(19) United States
(12) Patent Application Publication
(10) Pub. No.: US 2010/0018845 A1
(43) Pub. Date: Jan. 28, 2010

(54) LIGHT GUIDE PLATE AND ILLUMINATED KEYBOARD

(75) Inventor: Chin Hung Lin, Taoyuan (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Darfon Electronics Corp., Taoyuan (TW)

(21) Appl. No.: 12/507,401

(22) Filed: Jul. 22, 2009

(30) Foreign Application Priority Data
Jul. 23, 2008 (TW) 097213130

(51) Int. Cl. H01H 9/00; F21V 7/00

(52) U.S. Cl. 200/314; 362/296.01

(57) ABSTRACT

The invention discloses a light guide plate applied to an illuminated keyboard. A plurality of keyswitch modules is installed on the illuminated keyboard. The light guide plate is disposed beneath the keyswitch modules. The light guide plate comprises a main body and a reflective portion printed on a bottom of the main body. A light source is disposed close to the main body of the light guide plate. If the light source emits white light, the color of the reflective portion is different from that of the light source. If the light source emits non-white light, the color of the reflective portion is the same as that of the light source. Accordingly, the luminance will be greatly enhanced.

### BACKGROUND OF THE INVENTION

1. Field of the Invention

The invention relates to a light guide plate, and more particularly, to a light guide plate enhancing the luminance effect by changing the color of the printed ink and an illuminated keyboard using the light guide plate.

2. Description of the Prior Art

When a user uses a personal computer, a keyboard is one of the necessary inputting devices used for inputting words, symbols, or numbers. Additionally, the keyswitch structure is set on the consumer electronic products used in our daily life or the large-sized manufacturing apparatus used in industry as the inputting apparatus to operate the above-mentioned electronic products or manufacturing apparatus.

Please refer to FIG. 1. FIG. 1 shows a cross-sectional view of a keyswitch module 1 in the prior art. As shown in FIG. 1, the conventional keyswitch module 1 includes a keycap 10, a substrate 12, a circuit board 14, a supporting device 16 and an elastic component 18. The supporting device 16 and the elastic component 18 are both set between the keycap 10 and the substrate 12, wherein the supporting device 16 makes the keycap 10 capable of moving upward and downward relative to the substrate 12, and the elastic component 18 is used for supporting the keycap 10. The circuit board 14 is set on the substrate 12.

As the computer becomes more and more popular, users have more chances to use the computer in different conditions and environments. If the user is in a light-insufficient environment, the conditions of touching wrong keys will usually happen. Thus, the illuminated keyboard is developed. As shown in FIG. 1, a light source 20 and a light guide plate 22 are added under the conventional keyswitch module 1 to form the illuminated keyboard. The light source 20 can be a light emitting diode (LED).

Please refer to FIG. 2. FIG. 2 shows a bottom view of the light source 20 and the light guide plate 22 of FIG. 1. Conventionally, a white ink 220 corresponding to the light source 20 is printed on the light guide plate 22, so that the light emitted from the light source 20 can be reflected by the white ink 220 to enhance the luminance effect. However, since the white ink 220 is printed in the conventional light guide plate 22, if the light emitted from the light source 20 is not the white light (e.g., a blue light, a red light, and so on), the luminance effect reflected by the white ink 220 will become poor, and the visual effect when the user uses the illuminated keyboard will be also affected.

Moreover, if the user wants that some keyswitch modules of the illuminated keyboard show different colors, the light source 20 capable of emitting lights of different colors is needed, and the manufacturing cost will be increased accordingly.

Therefore, the invention provides a light guide plate and an illuminated keyboard using the light guide plate to solve the above-mentioned problems.

### SUMMARY OF THE INVENTION

A scope of the invention is to provide a light guide plate to enhance the luminance effect by changing the color of the printed ink.

According to an embodiment of the invention, the light guide plate cooperates with a light source to effectively reflect the lights emitted from the light source, so that the luminance effect will be greatly enhanced. The light guide plate includes a main body and a reflective portion. The light source is disposed near the main body of the light guide plate, and the reflective portion is printed on a bottom of the main body.

In practical applications, if the light source is a white light source, an ink having a color different from the white light source is printed on the bottom of the main body to be the above-mentioned reflective portion. By doing so, the white light source can emit the lights having the same color with the printed ink via the light guide plate by changing the color of the reflective portion without changing the light source.

In practical applications, if the light source is a non-white light source, an ink having a color the same with the non-white light source is printed on the bottom of the main body to be the above-mentioned reflective portion. By doing so, no matter what color the light emitted from the non-white light source is, the light will be reflected by the ink with the same color to enhance the luminance effect.

Another scope of the invention is to provide an illuminated keyboard. The illuminated keyboard includes a plurality of keyswitch modules and a light guide plate and a light source disposed beneath the keyswitch modules. The arrangement and design of the light guide plate and the light source are mentioned above.

The advantage and spirit of the invention may be further understood by the following recitations together with the appended drawings.

### BRIEF DESCRIPTION OF THE APPENDED DRAWINGS

FIG. 1 shows a cross-sectional view of the keyswitch in the prior art.

FIG. 2 shows a bottom view of the light source and the light guide plate in FIG. 1.

FIG. 3 shows a scheme diagram of the illuminated keyboard in an embodiment according to the invention.

FIG. 4 shows a cross-sectional view of the keyswitch module along the X-X line in FIG. 3.

FIG. 5 shows an exploded view of the keyswitch module in FIG. 4.

FIG. 6 shows a top view of the white light source and the light guide plate in FIG.

FIG. 7 shows a scheme diagram of the light guide plate in another embodiment according to the invention.

FIG. 8 shows a cross-sectional view of the keyswitch module in another embodiment according to the invention.

FIG. 9 shows a top view of the non-white light source and the light guide plate in FIG. 8.

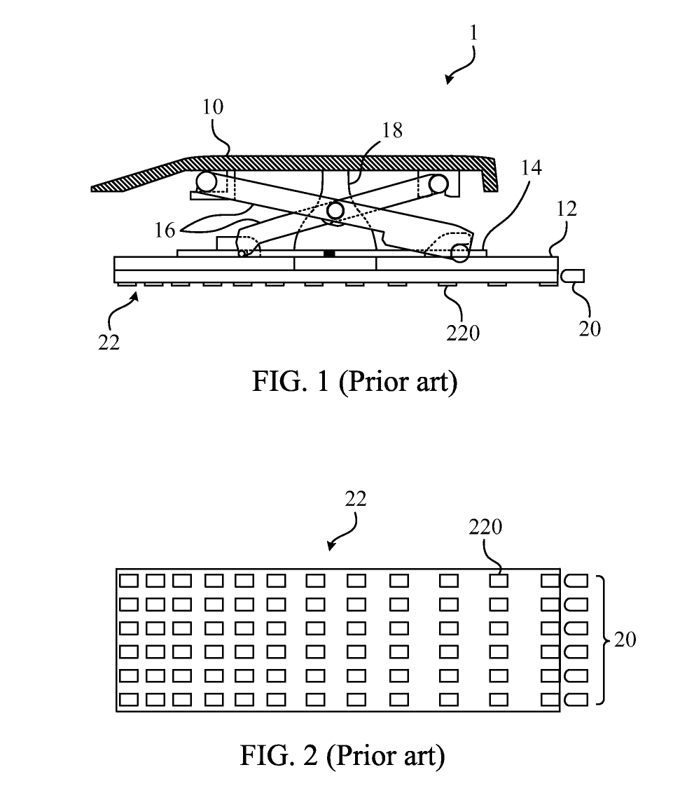

### DETAILED DESCRIPTION OF THE INVENTION

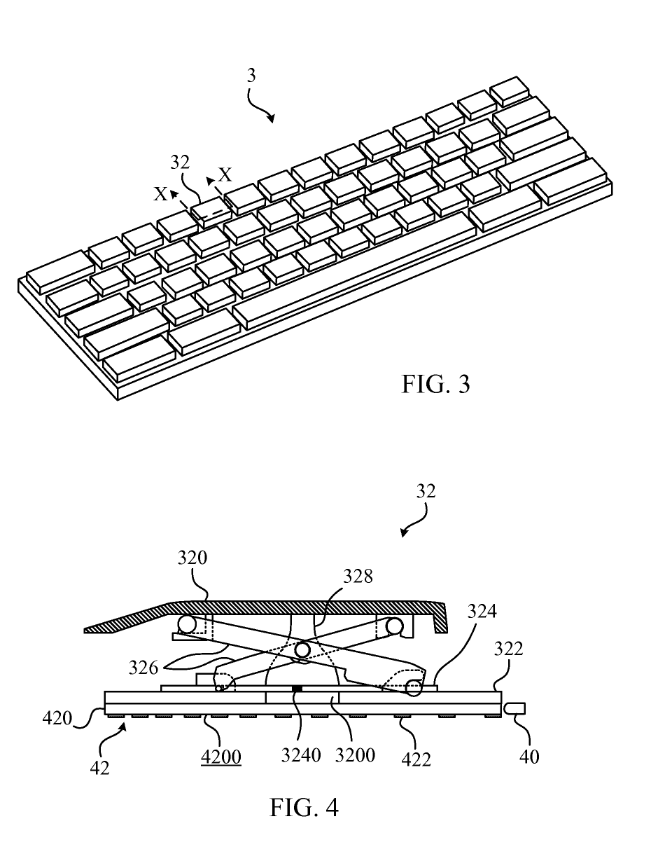

Please refer to FIG. 3. FIG. 3 shows a scheme diagram of the illuminated keyboard 3 in an embodiment according to the invention. As shown in FIG. 3, the illuminated keyboard 3 includes a plurality of keyswitch modules 32. The keyswitch module 32 is used for the user to press to perform the function the user wants to input.

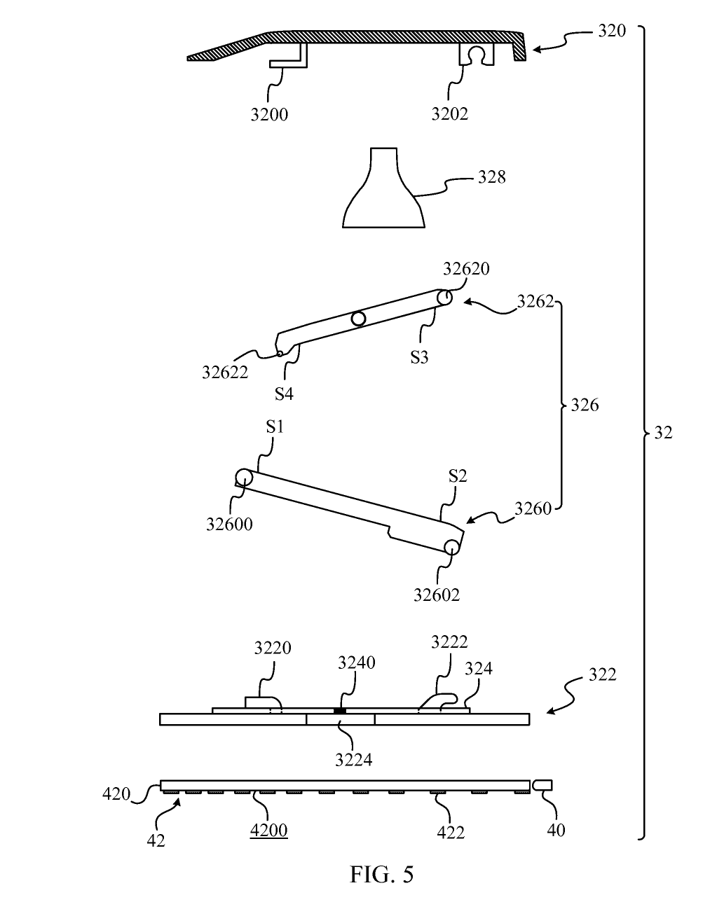

Please refer to FIG. 4 and FIG. 5. FIG. 4 shows a cross-sectional view of the keyswitch module 32 along the X-X line in FIG. 3. FIG. 5 shows an exploded view of the keyswitch module 32 in FIG. 4. In this embodiment, the keyswitch module 32 includes a keycap 320, a substrate 322, a circuit board 324, a supporting device 326, and an elastic component 328. The supporting device 326 and the elastic component 328 are both disposed between the keycap 320 and the substrate 322, wherein the supporting device 326 can make the keycap 320 capable of moving upward and downward relative to the substrate 322, and the elastic component 328 is used for supporting the keycap 320.

In this embodiment, the elastic component 328 is made of rubber or other elastic materials. The circuit board 324 is disposed on the substrate 322, wherein the circuit board 324 has a switch 3240. The witch 3240 can be a thin film switch or other trigger switches depending on the actual applications. In addition, the substrate 322 has a through hole 3224 corresponding to the keycap 320, so that the light can be emitted from the underside of the substrate 322.

As shown in FIG. 5, the keycap 320 has a first sliding groove 3200 and a first wedging groove 3202, and the substrate 322 has a second sliding groove 3220 and a second wedging groove 3222. The supporting device 326 includes a first supporting component 3260 and a second supporting component 3262, wherein the first supporting component 3260 and the second supporting component 3262 are pivotally connected to be a type of scissors, as shown in FIG. 4.

As shown in FIG. 5, a first side S1 and a second side S2 are defined on the first supporting component 3260. The first side S1 has a first sliding axis 32600 and the second side S2 has a first rotating axis 32602. When fabricating, the first sliding axis 32600 can be slidably disposed in the first sliding groove 3200 of the keycap 320, and the first rotating axis 32602 can be rotatably disposed in the second wedging groove 3222 of the substrate 322. Moreover, a third side S3 and a fourth side S4 are defined on the second supporting component 3262. The third side S3 has a second rotating axis 32620 and the fourth side S4 has a second sliding axis 32622. When fabricating, the second rotating axis 32620 can be rotatably disposed in the first wedging groove 3202 of the keycap 320, and the second sliding axis 32622 can be slidably disposed in the second sliding groove 3220 of the substrate 322. Accordingly, when the keycap 320 is pressed, the keycap 320 can move upward and downward relative to the substrate 322 along with the supporting device 326.

As shown in FIG. 4, the light guide plate 42 is disposed beneath the substrate 322 of the keyswitch modules 32. The light guide plate 42 includes a main body 420 and a reflective portion 422. A white light source 40 is disposed near the main body 420 of the light guide plate 42; the reflective portion 422 is printed on a bottom 4200 of the main body 420. In this embodiment, the white light source 40 can be a white light LED, but not limited to this. The main body 420 of the light guide plate 42 can be made of transparent material, such as acrylic, polycarbonate (PC), or acrylonitrile-butadiene-atyrene (ABS).

Please refer to FIG. 6. FIG. 6 shows a top view of the white light source 40 and the light guide plate 42 in FIG. 5. As shown in FIG. 6, the arrangement of the reflective portion 422 near the white light source 40 is denser than that of the reflective portion 422 distant from the white light source 40. With that, the lights emitted from the white light source 40 can be uniformly reflected by the reflective portion 422 of the light guide plate 42 instead of the condition of lightness nonuniformity.

In this embodiment, since the light source used is a white light source, the ink having a color different from the white light source 40 is printed on the bottom 4200 of the light guide plate 42 to be the above-mentioned reflective portion 422. After the light emitted from the white light source 40 is reflected by the reflective portion 422, the light having the same color with the reflective portion 422 will be radiated.

For example, if a blue ink is printed on the bottom 4200 of the light guide plate 42, the light emitted from the white light source 40 can be reflected by the blue ink, and the reflected light will be a blue light; if a red ink is printed on the bottom 4200 of the light guide plate 42, the light emitted from the white light source 40 can be reflected by the red ink, and the reflected light will be a red light, and so on. Therefore, the white light source 40 can emit the same color light with the printed ink via the light guide plate 42 by changing the color of the reflective portion 422 without changing the light source.

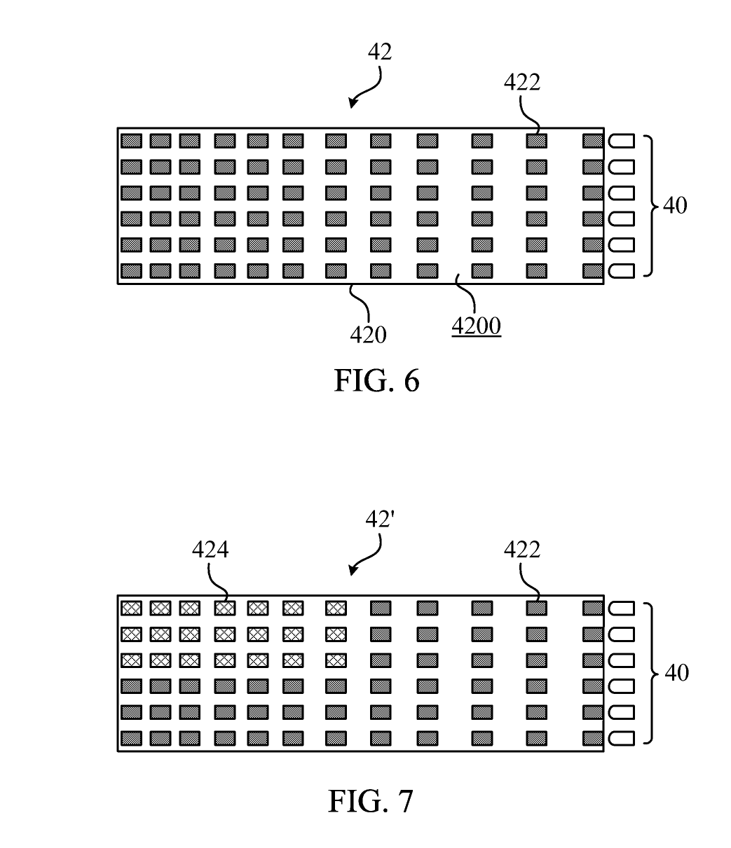

Please refer to FIG. 7. FIG. 7 shows a light guide plate 42′ in another embodiment according to the invention. The main difference between the light guide plate 42′ and the above-mentioned light guide plate 42 is that not only the reflective portion 422 is printed on the light guide plate 42′, but also another reflective portion 424 is printed on the light guide plate 42′. For example, if the reflective portion 422 is blue ink and the reflective portion 424 is red ink, when the light emitted from the white light source 40 is reflected by the reflective portion 422 and the reflective portion 424 respectively, the blue light and the red light can be generated at the same time. In other words, the color of the light emitted from the light source can be freely changed by printing the ink having different colors without changing the light source.

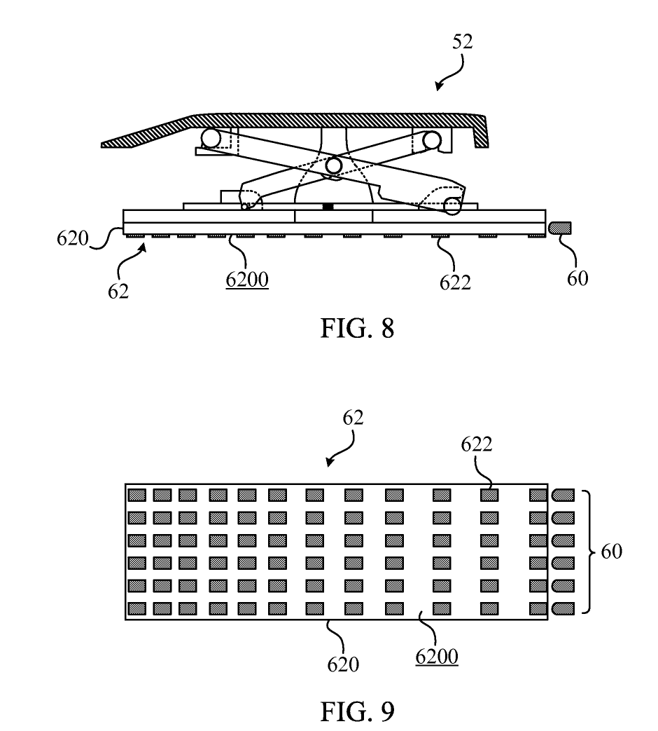

Please refer to FIG. 8 and FIG. 9. FIG. 8 shows a cross-sectional view of a keyswitch module 52 in another embodiment according to the invention. FIG. 9 shows a top view of the non-white light source 60 and the light guide plate 62 in FIG. 8. It should be noticed that the design of the structure of the keyswitch module 52 is approximately the same with that of the keyswitch module 32 in FIG. 4, so that it is not mentioned again here.

As shown in FIG. 8, the light guide plate 62 includes a main body 620 and a reflective portion 622. The non-white light source 60 is disposed near the main body 620 of the light guide plate 62. The reflective portion 622 is printed on a bottom 6200 of the main body 620. In this embodiment, the non-white light source 60 can be a non-white light LED, but it is not limited to this. The main body 620 of the light guide plate 62 can be made of transparent material, such as acrylic, polycarbonate (PC), or acrylonitrile-butadiene-atyrene (ABS).

In this embodiment, since the light source used is non-white light source, the ink having the same color with the non-white light source 60 is printed on the bottom 6200 of the light guide plate 62 to be the above-mentioned reflective portion 622. When the light emitted from the non-white light source 60 is reflected by the reflective portion 622, the luminance effect will be effectively enhanced. In other words, the color of the ink printed on the reflective portion 622 can be changed with the color of the non-white light source 60, so that the luminance effect will be effectively enhanced.

Compared to the prior arts, if the light source is a white light source, the ink having different color from the white light source is printed on the bottom of the light guide plate to be the above-mentioned reflective portion in this invention. Thus, the white light source can emit the same color light with the printed ink via the light guide plate by changing the color of the reflective portion without changing the light source. If the light source is a non-white light source, the ink having the same color with the non-white light source is printed on the bottom of the light guide plate to be the above-mentioned reflective portion in this invention. Thus, no matter what color the light emitted from the non-white light source is, the light will be reflected by the ink with the same color to enhance the luminance effect.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. A light guide plate, cooperating with a white light source, the light guide plate comprising:
a main body, the white light source being disposed near the main body; and
a first reflective portion, printed on a bottom of the main body, the color of the first reflective portion being different from the color of the white light source.

2. The light guide plate of claim 1, further comprising a second reflective portion printed on the bottom of the main body, the color of the second reflective portion being different from the color of the first reflective portion.

3. The light guide plate of claim 1, wherein the white light source is a white light emitting diode (LED).

4. An illuminated keyboard, comprising:
a plurality of keyswitch modules;
a light guide plate, disposed beneath the plurality of keyswitch modules, the light guide plate comprising:
a main body; and
a first reflective portion, printed on a bottom of the main body; and
a white light source, disposed near the main body of the light guide plate, the color of the first reflective portion being different from the color of the white light source.

5. The illuminated keyboard of claim 4, wherein the light guide plate further comprises a second reflective portion printed on the bottom of the main body, the color of the second reflective portion is different from the color of the first reflective portion.

6. The illuminated keyboard of claim 4, wherein the white light source is a white light LED.

7. The illuminated keyboard of claim 4, wherein each of the plurality of keyswitch modules comprises:
a keycap;
a substrate, the substrate having a through hole corresponding to the keycap;
a circuit board, disposed on the substrate;
a supporting device, disposed between the keycap and the substrate, for making the keycap capable of moving upward and downward relative to the substrate; and
an elastic component, disposed between the keycap and the substrate, for supporting the keycap.

8. A light guide plate, cooperating with a non-white light source, the light guide plate comprising:
a main body, the non-white light source being disposed near the main body; and
a reflective portion, printed on a bottom of the main body, the color of the reflective portion being the same with the color of the non-white light source.

9. The light guide plate of claim 8, wherein the non-white light source is a non-white light LED.

10. An illuminated keyboard, comprising:
a plurality of keyswitch modules;
a light guide plate, disposed beneath the plurality of keyswitch modules, the light guide plate comprising:
a main body; and
a reflective portion, printed on a bottom of the main body; and
a non-white light source, disposed near the main body of the light guide plate, the color of the reflective portion being the same with the color of the non-white light source.

11. The illuminated keyboard of claim 10, wherein the non-white light source is a non-white light LED.

12. The illuminated keyboard of claim 10, wherein each of the plurality of keyswitch modules comprises:
a keycap;
a substrate, the substrate having a through hole corresponding to the keycap;
a circuit board, disposed on the substrate;
a supporting device, disposed between the keycap and the substrate, for making the keycap capable of moving upward and downward relative to the substrate; and
an elastic component, disposed between the keycap and the substrate, for supporting the keycap.
